(19) United States
(12) Patent Application Publication
(10) Pub. No.: US 2013/0111779 A1
(43) Pub. Date: May 9, 2013

(54) DEVICE FOR DRYING FOOD CONTAINERS

(71) Applicant: Jin Young Lee, Pyongteak-si (KR)

(72) Inventor: Jin Young Lee, Pyongteak-si (KR)

(21) Appl. No.: 13/807,450

(22) PCT Filed: Jun. 27, 2011
(86) PCT No.: PCT/KR11/04684

§ 371 Date: Jan. 22, 2013

(30) Foreign Application Priority Data
Jun. 29, 2010 (KR) 10-2010-0061962

(51) Int. Cl. F26B 20/00

(52) U.S. Cl. CPC F26B 20/00
USPC 34/275; 34/202

(57) ABSTRACT

A device for drying food containers is provided. The device for drying food containers includes: a holder portion providing an accommodation space; a support portion vertically detachably connected to the holder portion and formed in a pole shape; and a plurality of hanger portions slantly connected to the support portion. The holder portion includes an accommodation container body and an accommodation cover. The accommodation container body includes: an accommodation container body defining an accommodation space; and an accommodation container connection portion connected to the support portion. The accommodation cover includes: an accommodation cover body formed corresponding to a shape of the accommodation container body and connected to a top surface of the accommodation container body, a central region of the accommodation cover body being lower than a peripheral region of the accommodation cover; and an accommodation cover hole formed in the central region of the accommodation cover body.

### TECHNICAL FIELD

The present invention relates to a device for drying food containers, and more particularly, to a device for drying food containers, which can naturally dry a baby bottle and perform ultraviolet sterilization up to a deep site of the baby bottle.

### BACKGROUND ART

Baby bottles designed to feed infants milk or beverage to infants have been developed in various types and structures. A baby bottle includes a container with a neck for storing contents, a nipple mounted on the neck of the container, an adapter for connecting the nipple to the neck of the container, and a cap for protecting the nipple. For reusing the baby bottle after feeding contents to an infant by using the baby bottle, it is necessary to wash the container and the nipple clean with water to remove the contents left thereon, sterilize the container and the nipple with boiling water, and then dry the container and the nipple to remove water therefrom. Washing, sterilizing and drying of the baby bottle are considered as very important to the infant because the infant who is easily exposed to disease germ bits the nipple with his/her mouth and takes the contents contained in the bottle. In most of families or child-care centers, after washing and sterilizing the container and the nipple, the container and the nipple are dried to remove water therefrom, while standing erect on a sink or dish dryer. During the drying of the container and the nipple on the sink, the bottle and the nipple may be easily contaminated by foreign substance.

Usually, an infant uses a baby bottle for about six months to one year. An existing baby bottle dryer is made only for the purpose of drying the baby bottle during this period. At the time when the baby bottle need not be dried any more, the baby bottle dryer is discarded or left alone. Also, a product of a horizontal space utilization type has a problem that takes up much space.

In addition, in the case of an ultraviolet sterilizer, a container put on a box-shaped shelf is sterilized or dried. It is difficult to sterilize a deep site of the container. It is unsanitary because water is left on the bottom. Also, since it is bulky in volume, it is inconvenient to carry.

### SUMMARY OF INVENTION

### Technical Problem

The present invention has been made in an effort to solve the problems occurring in the related art, and is directed to provide a device for drying food containers, which can naturally dry a baby bottle and perform ultraviolet sterilization up to a deep site of a baby bottle.

### Solution to Problem

According to an embodiment of the present invention, a device for drying food containers includes: a holder portion providing an accommodation space; a support portion vertically detachably connected to the holder portion and formed in a pole shape; and a plurality of hanger portions slantly connected to the support portion, wherein the holder portion includes: an accommodation container including an accommodation container body defining an accommodation space, and an accommodation container connection portion connected to the support portion; and an accommodation cover including an accommodation cover body formed corresponding to a shape of the accommodation container body and connected to a top surface of the accommodation container body, a central region of the accommodation cover body being lower than a peripheral region of the accommodation cover, and an accommodation cover hole formed in the central region of the accommodation cover body.

The support portion includes two or more support poles, and each of the support poles includes: a support pole body; a support pole connection portion protruding from the support pole body and inclined with respect to the support pole body; and a support pole connection protrusion inserted into and connected to the holder portion or another support pole.

Each of the hanger portions includes: a hanger portion body elongated in a bar shape; and a hanger portion connection protrusion protruding from one end of the hanger portion body and inserted into and connected to the support pole connection portion.

The device further includes: an ultraviolet sterilizing unit disposed inside the hanger portion to emit ultraviolet light; a power supply installed inside the support portion to provide power for driving the ultraviolet sterilizing unit; and a socket installed inside the support pole connection portion, such that the socket is electrically connected to the power supply, and connected to the ultraviolet sterilizing unit.

The ultraviolet sterilizing unit is an ultraviolet lamp or an ultraviolet LED unit.

The hanger portion is made of a light transmitting material, and a plurality of diffusion protrusions are formed in the hanger portion.

The device further includes a blower fan installed inside the support portion body, wherein each of the hanger portions includes: a hanger portion body; and a plurality of holes formed on the hanger portion body.

### Advantageous Effects of Invention

According to the present invention, a plurality of hanger portions are slantly connected to a support portion. If a food container, including a baby bottle or a cup, is hanged on a hanger portion, water left in the food container is collected to a holder portion along the support portion. The inside of the food container can also be sterilized through an ultraviolet sterilizing unit installed in each hanger portion.

A variety of miscellaneous utensils can be hanged on a protrusion formed in the hanger portion, thereby maximizing user convenience.

Each component is easily dissembled and assembled. When completely disassembled, each component can be accommodated in an accommodation space of the holder portion. Therefore, the device for drying food containers is easy to carry.

In addition, after completely assembled, the shape of the device for drying food containers is a tree branch shape. Therefore, the device for drying food containers can be used as interior accessories. Even when the function of drying the baby bottle becomes unnecessary, the device for drying food container can be used as interior accessories.

### BRIEF DESCRIPTION OF DRAWINGS

FIG. 1 is a schematic perspective view of a device for drying food containers according to a first embodiment of the present invention.

FIG. 2 is an exploded perspective view of the device for drying food containers shown in FIG. 1.

FIG. 3 illustrates a water gathering function of the device for drying food containers according to the present invention.

FIGS. 4 and 5 illustrate a state in which the food container is disposed in the device for drying food containers according to the present invention.

FIG. 6 is an exploded perspective view of a device for drying food containers according to a second embodiment of the present invention.

FIG. 7 illustrates a hanger portion of a device for drying food containers according to a third embodiment of the present invention.

FIG. 8 illustrates an ultraviolet light source unit of a device for drying food containers according to a fourth embodiment of the present invention.

FIG. 9 is a schematic perspective view of a device for drying food containers according to a fifth embodiment of the present invention.

### DESCRIPTION OF EMBODIMENTS

Hereinafter, preferred embodiments of the present invention will be described in detail with reference to the accompanying drawings.

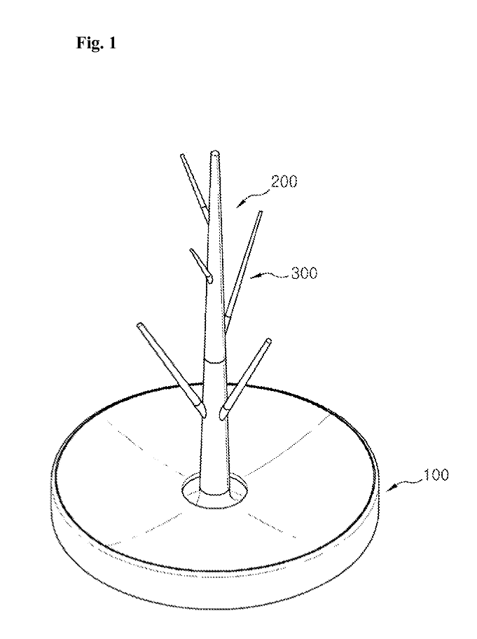

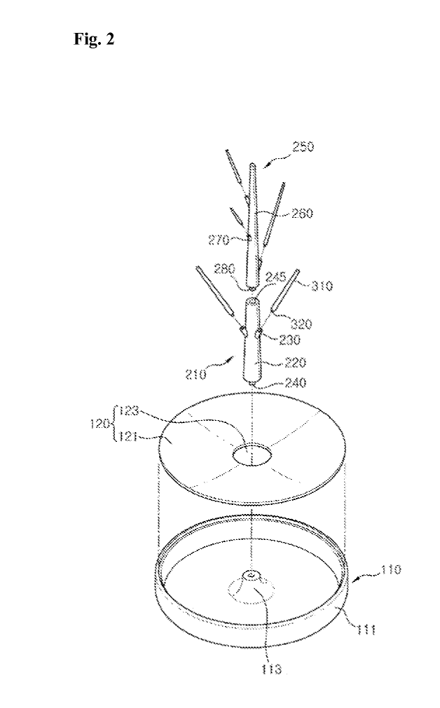

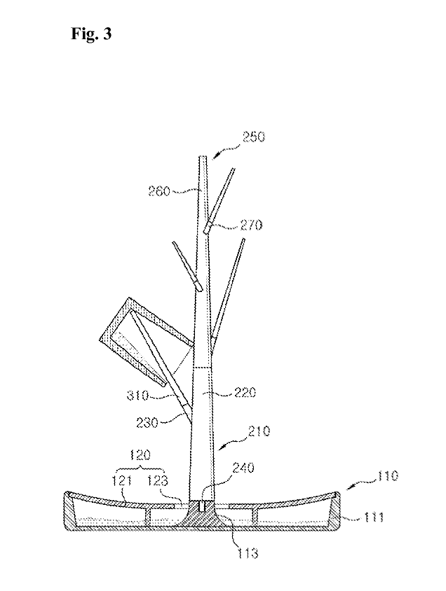

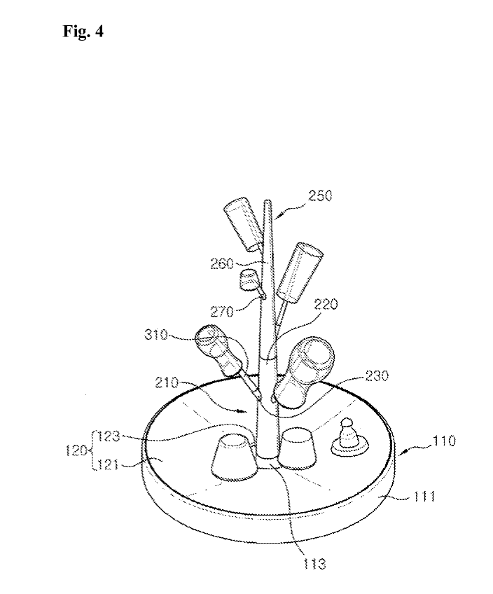

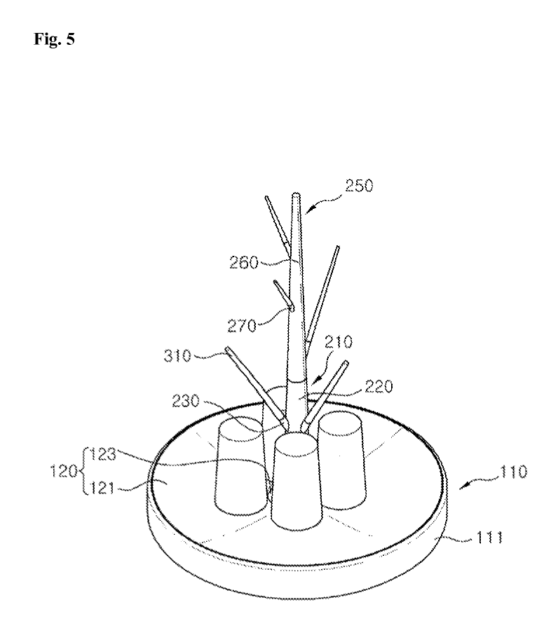

FIG. 1 is a schematic perspective view of a device for drying food containers according to a first embodiment of the present invention. FIG. 2 is an exploded perspective view of the device for drying food containers illustrated in FIG. 1. FIG. 3 illustrates a water gathering function of the device for drying food containers according to the present invention. FIGS. 4 and 5 illustrate a state in which the food container is disposed in the device for drying food containers according to the present invention.

Referring to FIG. 1, the device for drying food containers according to the first embodiment of the present invention includes a holder portion 100, a support portion 200, and a hanger portion 300.

The holder portion 100 functions to support the device for drying food containers, and provides a space for accommodating each component of the device for drying food containers. The support portion 200 is elongated in a pole shape as a whole, and is vertically detachably connected to the holder portion 100. Although the support portion 200 may be formed with a single pole, the support portion 200 are formed with at least two or more poles for convenient accommodation and easy to carry. The hanger portion 300 is provided in plurality, and each hanger portion 300 is slantly connected to the support portion 200.

Referring to FIG. 2, each component will be described in more detail.

The holder portion 100 includes an accommodation container 110 defining an accommodation space, and an accommodation cover 120 connected to the accommodation container 110 and formed to allow residual water to flow toward the accommodation container 110.

The accommodation container 110 includes an accommodation container body 111 and an accommodation container connection portion 113. The accommodation container body 111 is formed in a cylindrical shape such that the accommodation space is formed inside and the upper side is opened. In this embodiment, the accommodation container body 111 is formed in the cylindrical shape, but the shape of the accommodation container body 111 is not limited thereto. The accommodation container body 111 may be formed in various shapes, for example, in a polyprism or cylindroid shape. The accommodation container connection portion 113 is formed in the central region of the accommodation container body 111. A first support pole connection protrusion of the support portion 200, which is to be described below, is inserted into and connected to the accommodation container connection portion 113.

The accommodation cover 120 includes an accommodation cover body 121 and an accommodation cover hole 123. The accommodation cover body 121 is formed corresponding to the shape of the accommodation container body 111 and is connected to the top surface of the accommodation container body 111. In this case, the accommodation cover body 121 is fitted to the accommodation container body 111. On the other hand, although not illustrated, a magnet (not illustrated) may be installed, and the accommodation cover body 121 may be connected to the accommodation container body 111 by the magnet.

In addition, the accommodation cover body 111 is formed such that a central region is lower than a peripheral region. That is, the central region is concavely formed. The accommodation cover hole 123 is formed in the central region of the accommodation cover body 121. As such, if the central region of the accommodation cover body 121 is concavely formed, water falls into the accommodation cover 120 when the food container or other things, in which water is left, are put on the accommodation cover 120. The water fallen into the accommodation cover 120 runs down to the central region and is collected at the accommodation container body 111 through the accommodation cover hole 120 formed in the central region. As a result, no water is left on the accommodation cover 120. Hence, a clean state can be maintained, and a user has only to remove and clean the residual water collected in the accommodation container body 111. Therefore, it is possible to obtain the effect that user convenience is remarkably improved.

The support portion 200 includes a first support pole 210, one end of which is connected to the holder portion 100, and a second support pole 250, one end of which is connected to the first support pole 210. In this embodiment, it has been described that two support poles are mutually connected to form the support portion 200, but there is no limitation to the number of the support poles.

The first support pole 210 includes a first support pole body 220, a first support pole connection portion 230, a first support pole connection protrusion 240, and a first support pole connection hole 245. The first support pole body 220 is formed in a bar shape. The first support pole connection portion 230 protrudes from the first support pole body 220 and is inclined with respect to the first support pole body 220. The first support pole connection portion 230 may be formed in plurality, and the hanger portion 300 is inserted into and connected to each first support pole connection portion 230. The first support pole connection protrusion 240 protrudes from one end of the first support pole body 220 and is inserted into and connected to the accommodation container connection portion 113. The first support pole connection hole 245 is formed at the other end of the first support pole body 220 to define a hole into which a second support pole connection protrusion 280 to be described below is inserted.

The second support pole 250 includes a second support pole body 260, a second support pole connection portion 270, and the second support pole connection protrusion 280. The second support pole body 260 is formed in a bar shape. The second support pole connection portion 270 protrudes from the second support pole body 260 and is inclined with respect to the second support pole body 260. The second support pole connection protrusion 280 protrudes from one end of the second support pole body 260 and is inserted into and connected to the first support pole connection hole 245.

The respective hanger portions 300 are inserted into and connected to the first support pole connection portion 230 and the second support pole connection portion 270. The hanger portion 300 includes a hanger portion body 310 elongated in a bar shape, and a hanger portion connection protrusion 320 protruding from one end of the hanger portion body 310 and inserted into and connected to the first support pole connection portion 230 and the second support pole connection portion 270. Meanwhile, although not illustrated, a hanger protrusion (not illustrated) may protrude from the hanger portion body 310 so that miscellaneous utensils can be hanged thereon.

FIG. 3 illustrates a state in which when a wet cup is hanged on the device for drying food containers according to the present invention, water left in the cup flows along the hanger portion and the support portion and is collected in the holder portion. FIG. 4 illustrates a case where a baby bottle is hanged on the hanger portion and is naturally dried. FIG. 5 illustrates a case where a cup is put on the accommodation cover of the holder portion so that water is removed from the cup.

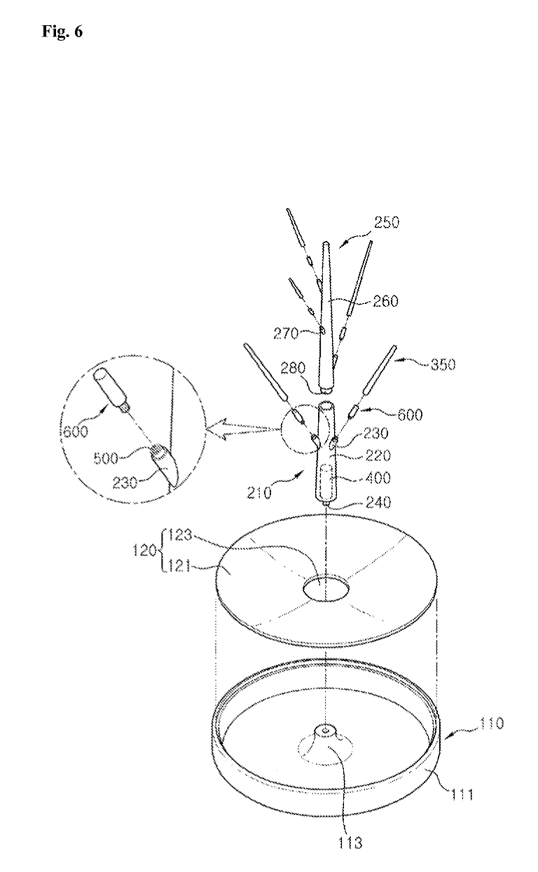

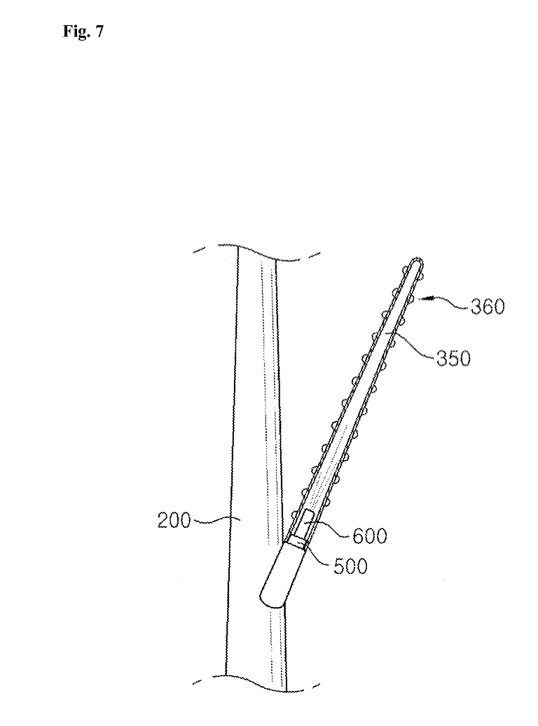

FIG. 6 is an exploded perspective view of a device for drying food containers according to a second embodiment of the present invention, and FIG. 7 illustrates a hanger portion of a device for drying food containers according to a third embodiment of the present invention.

Referring to FIG. 6, the device for drying food containers according to the embodiment of the present invention includes a holder portion 100, a support portion 200, a hanger portion 350, a power supply 400, a socket 500, and an ultraviolet lamp 600.

The holder portion 100 functions to support the device for drying food containers, and provides a space for accommodating each component of the device for drying food containers. The support portion 200 is elongated in a pole shape as a whole, and is vertically detachably connected to the holder portion 100. Although the support portion 200 may be formed with a single pole, the support portion 200 are formed with at least two or more poles for convenient accommodation and easy to carry. The hanger portion 350 is provided in plurality, and each hanger portion 350 is slantly connected to the support portion 200. The power supply 400 is installed inside the support portion 200, and supply power for driving the ultraviolet lamp 600. The socket 500 is connected to the power supply 400 and is installed inside the support portion 200. The ultraviolet lamp 600 is inserted into and fixed to the socket 500, and is supplied with the power from the power supply 400 to emit ultraviolet light. Each hanger portion 350 is connected to the support portion 200, with the ultraviolet lamp 600 being disposed inside the hanger portion 350. That is, the ultraviolet lamp 600 is disposed inside each hanger portion 350.

The configurations of the socket 500 and the ultraviolet lamp 600 will be described in more detail. Since the other configurations are substantially similar to the configuration of the first embodiment, a description thereof will be omitted. The socket 500 is installed inside each support pole connection portion, that is, the first support pole connection portion 230 and the second support pole connection portion 270. Although not illustrated, the socket 500 is electrically connected to the power supply 400.

Like in the embodiment, the ultraviolet lamp 600 emitting ultraviolet light may use a lamp having a relatively short length as compared with the hanger portion 350. Unlike this, a lamp having a long length corresponding to the length of the hanger portion 350 may also be used. The ultraviolet lamp 600 is inserted into and connected to the socket 500 and is supplied with the power from the power supply 400 to emit ultraviolet light. Although not illustrated, a switch (not illustrated) having a function of turning on/off the power supply 400 is provided at the support portion 200 or the holder portion 100. The switch (not illustrated) controls the on/off operation of the ultraviolet lamp 600.

The hanger portion 350 is made of a light transmitting material so that ultraviolet light emitted from the ultraviolet lamp 600 can be transmitted to the exterior.

FIG. 7 illustrates a hanger portion of a device for drying food containers according to a third embodiment of the present invention. A plurality of diffusion protrusions 360 are formed on the outer surface of the hanger portion 350, so that ultraviolet light from the ultraviolet lamp 600 can be emitted through the hanger portion 350 in multiple directions. As a result, the inner surface of the food container hanged on the hanger portion 350 is uniformly sterilized by the ultraviolet light, thereby improving sterilization effect.

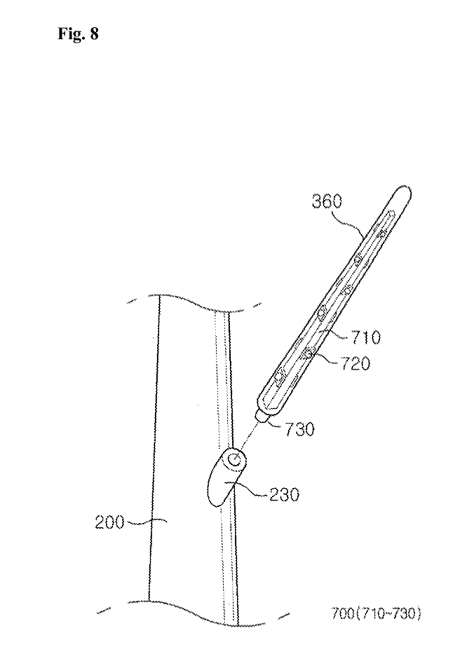

FIG. 8 illustrates an ultraviolet LED unit of a device for drying food containers according to a fourth embodiment of the present invention. In the fourth embodiment illustrated in FIG. 8, an ultraviolet LED unit, instead of the ultraviolet lamp, is used as an ultraviolet sterilizing unit. The following description will focus on the different configuration from the foregoing embodiment, and the description of the same configuration will be omitted.

Referring to FIG. 8, the ultraviolet LED unit 700 is elongated in a bar shape as a whole and is disposed inside the hanger portion 350. The ultraviolet LED unit 700 includes a bar-type printed circuit board 710, a plurality of ultraviolet LED packages 720 installed on the printed circuit board 710, and a connection portion 730 inserted into and connected to the socket 500 and supplied with power from a power supply (not illustrated). The plurality of ultraviolet LED packages 720 are installed in different directions, such that ultraviolet light is emitted in multiple directions.

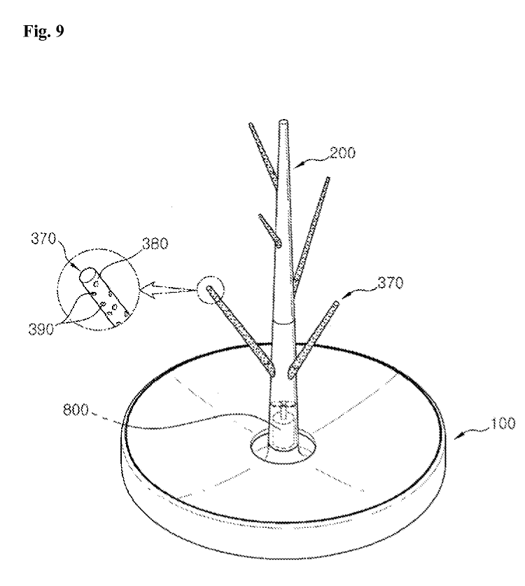

FIG. 9 is a schematic perspective view of a device for drying food containers according to a fifth embodiment of the present invention. In the embodiment illustrated in FIG. 9, a blower fan is installed, and the food container is dried by the wind generated by the blower fan.

Referring to FIG. 9, the device for drying food containers includes a holder portion 100, a hanger portion 370, and a blower fan 800.

The holder portion 100 functions to support the device for drying food containers, and provides a space for accommodating each component of the device for drying food containers. The support portion 200 is elongated in a pole shape as a whole, and is vertically detachably connected to the holder portion 100. Although the support portion 200 may be formed with a single pole, the support portion 200 are formed with at least two or more poles for convenient accommodation and easy to carry.

The hanger portion 370 is provided in plurality, and each hanger portion 300 is slantly connected to the support portion 200. Each hanger portion 370 includes a hanger portion body 380 and a plurality of holes 390 formed on the hanger portion body 380.

The blower fan 800 is installed inside the support portion 200, and the wind generated by the blower fan 800 is transferred to each hanger portion 370 through the support portion 200 and is discharged to the exterior through the plurality of holes 390 formed in the hanger portion 370. The food container hanged on each hanger portion 370 is dried by the window discharged through the plurality of holes 390.

The device for drying food containers according to the present invention, described above, is merely exemplary, and the present invention is not limited to the above embodiments. It will be apparent to those skilled in the art that various changes and modifications may be made without departing from the spirit and scope of the invention as defined in the appended claims.

1. A device for drying food containers, comprising:
a holder portion providing an accommodation space;
a support portion vertically detachably connected to the holder portion and formed in a pole shape; and
a plurality of hanger portions slantly connected to the support portion, wherein the holder portion comprises:
an accommodation container comprising:
an accommodation container body defining an accommodation space; and
an accommodation container connection portion connected to the support portion; and
an accommodation cover comprising:
an accommodation cover body formed corresponding to a shape of the accommodation container body and connected to a top surface of the accommodation container body, a central region of the accommodation cover body being lower than a peripheral region of the accommodation cover; and
an accommodation cover hole formed in the central region of the accommodation cover body.

2. The device of claim 1, wherein the support portion comprises two or more support poles, and each of the support poles comprises:
a support pole body;
a support pole connection portion protruding from the support pole body and inclined with respect to the support pole body; and
a support pole connection protrusion inserted into and connected to the holder portion or another support pole.

3. The device of claim 2, wherein each of the hanger portions comprises:
a hanger portion body elongated in a bar shape; and
a hanger portion connection protrusion protruding from one end of the hanger portion body and inserted into and connected to the support pole connection portion.

4. The device of claim 2, further comprising:
an ultraviolet sterilizing unit disposed inside the hanger portion to emit ultraviolet light;
a power supply installed inside the support portion to provide power for driving the ultraviolet sterilizing unit; and
a socket installed inside the support pole connection portion, such that the socket is electrically connected to the power supply, and connected to the ultraviolet sterilizing unit.

5. The device of claim 4, wherein the ultraviolet sterilizing unit is an ultraviolet lamp or an ultraviolet LED unit.

6. The device of claim 4, wherein the hanger portion is made of a light transmitting material, and a plurality of diffusion protrusions are formed in the hanger portion.

7. The device of claim 2, further comprising a blower fan installed inside the support portion body,
wherein each of the hanger portions comprises:
a hanger portion body; and
a plurality of holes formed on the hanger portion body.
